(19) United States
(12) Patent Application Publication
(10) Pub. No.: US 2009/0202253 A1
(43) Pub. Date: Aug. 13, 2009

(54) Optically isolated analog audio circuits

(76) Inventor: Joseph Maggett, Los Angeles, CA (US)

Correspondence Address: Arent Fox LLP, 555 West Fifth Street, 48th Floor, Los Angeles, CA, 90013, US

(21) Appl. No.: 12/069,181

(22) Filed: Feb. 7, 2008

(51) Int. Cl. H04B 10/00

(52) U.S. Cl. 398/140; 381/77

(57) ABSTRACT

An Audio circuit configured to receive an analog audio signal. The audio circuit includes an optical isolator having a LED configured to emit light modulated by the analog audio signal over a fiberless medium and a detector configured to replicate the analog audio signal received by the LED from the modulated light emitted from the LED.

### BACKGROUND

1. Field

The disclosure relates generally to the electronic arts, and more specifically to optically isolated analog audio circuits.

2. Background

Audio circuits are commonly used to reproduce sound in the audible frequency range (i.e., 20 Hz-20 KHz). A typical audio circuit includes an audio amplifier to amplify a low power audio signal to a level suitable to drive the next stage. This often present various challenges to the designer because sound usually contains multiple frequencies, all of which must be amplified by the same amount and with the same phase shift. An audio amplifier which amplifies all of the frequencies by the same amount while maintaining phase coherency over the full range of frequencies is said to be linear. In real world applications, however, the gain and/or delay of the amplifier may vary with frequency, thus introducing distortion into the audio signal. These amplifiers depend upon negative feedback to increase their linearity.

Despite the advantages, negative feedback can degrade sound quality by reducing the dynamic range of the audio signal. In the early days, when audio was strictly analog, some loss in dynamic range due to negative feedback was generally acceptable. However, today, with the advent of digital audio, the effect of negative feedback can more dramatic, often masking the benefits that digital audio can provide to sound quality. Accordingly, there is a need in the art for improved audio circuits that can reduce or eliminate distortion without significantly decreasing the dynamic range of digital and analog audio signals.

### SUMMARY

In one aspect of the disclosure, an audio circuit is configured to receive an analog audio signal. The audio circuit includes a light-emitting diode (LED) configured to emit light modulated by the analog audio signal over a fiberless medium, and a detector configured to replicate the analog audio signal received by the LED from the modulated light emitted from the LED.

In another aspect of the disclosure, an audio circuit includes an audio signal input, a LED coupled to the audio signal input, a detector optically coupled to the LED through a fiberless medium, an audio signal output, the detector being coupled to the audio signal output, and a voltage input, each of the LED and detector being coupled to the voltage input.

In yet another aspect of the disclosure, an audio circuit is configured to receive an analog audio signal. The audio circuit includes means for emitting light modulated by the analog audio signal over a fiberless medium, and means for replicating the analog audio signal in response to the emitted modulated light.

In a further aspect of the disclosure, an audio circuit is configured to receive an analog audio signal. The audio circuit includes an optical coupler configured to amplify the analog audio signal.

In yet a further aspect of the disclosure, an audio system is configured to receive an analog audio signal. The audio system includes a plurality of audio stages, wherein at least one of the stages includes an audio circuit having a LED configured to emit light modulated by the analog audio signal over a fiberless medium, and a detector configured to replicate the analog audio signal received by the LED from the modulated light emitted from the LED.

It is understood that other aspects of the invention will become readily apparent to those skilled in the art from the following detailed description, wherein various aspects of the invention are shown and described by way of illustration. As will be realized, the invention is capable of other and different configurations and implementations and its several details are capable of modification in various other respects, all without departing from the scope of this invention. Accordingly, the drawings and detailed description are to be regarded as illustrative in nature and not as restrictive.

### BRIEF DESCRIPTION OF THE DRAWINGS

Various aspects of an audio circuit are illustrated by way of example, and not by way of limitation, in the accompanying drawings, wherein:

FIG. 1 is a schematic diagram illustrating an example of an audio circuit; and

FIG. 2 is a functional block diagram illustrating an example of various permutations of an audio system.

### DETAILED DESCRIPTION

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well-known structures and components are omitted in order to avoid obscuring the concepts of the invention.

Various concepts will now be presented with reference to an audio circuit having an optical coupler. An optical coupler allows an analog audio signal to be amplified without distortion, loss, or decreased dynamic range and tends to correct distortion introduced by other active devices and reactive components. As a result, negative feedback can be eliminated throughout the amplifier chain, which preserves the dynamic range of the audio signal. An audio circuit of this type is well suited for audio applications where high quality sound reproduction is desirable, such as music, voice, and other similar applications, but may be extended to virtually any audio application, as well as circuits supporting other type of media. Accordingly, any reference to a specific audio application is intended only to illustrate various inventive aspects of the present invention, with the understanding that these inventive aspects have a wide range of applications

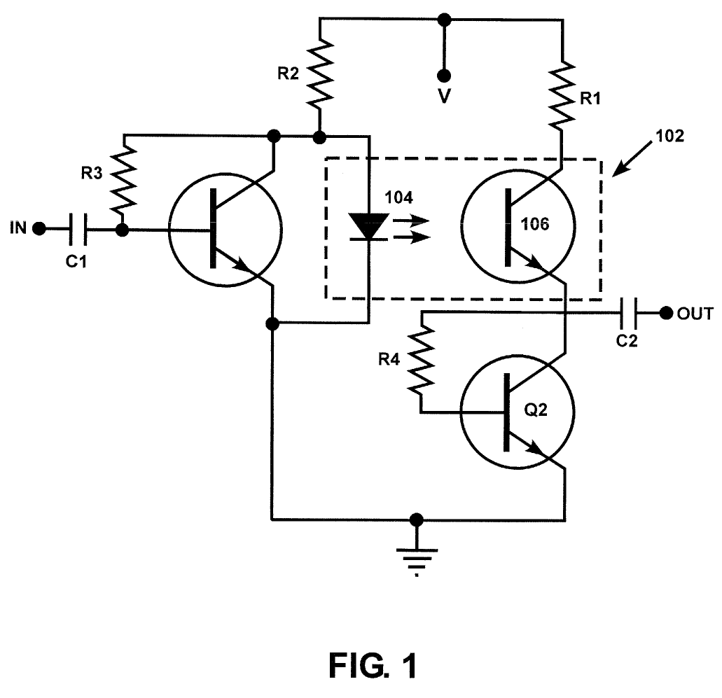

FIG. 1 is a schematic diagram of an embodiment of an audio circuit 100 with an optical coupler 102. The optical coupler 102 may include an emitter 104 combined with a detector 106 to provide an optically isolated signal path between the two components. The emitter 104 may be a light-emitting diode (LED) or some other suitable device. An example of a LED well suited for this application is an infrared (IR) LED. In this example, the detector 106 may be an IR detector, which acts as a transistor with the base voltage determined by the amount of light hitting the transistor. The transistor may be configured as an emitter-follower with a resistor R1 in the collector to establish the proper bias. In at least one embodiment of the audio circuit 102, the emitter 104 and detector 106 are powered from a common voltage source (not shown).

The audio circuit of FIG. 1 is shown with bipolar transistors supporting the operation of the optical coupler 102, but could be realized with field-effect transistors (FETs), metal-oxide-semiconductor FETs (MOSFETSs), valves (i.e., vacuum tubes), or other suitable devices. A transistor Q1 at the input of the audio circuit 100 provides a driver for the optical coupler 102 and allows the optical coupler 102 to operate as an amplifier, as opposed to a digital switch. The transistor Q1 may be configured as a common-emitter with a resistor network to establish the proper bias. The resistor network is shown with a R1 in the collector and resistor R2 between the collector and the base. The resistor R2 is also used to establish the bias current through the emitter 104 (e.g., LED) in the optical coupler 102.

The input audio signal is coupled through capacitor C1 to the base of a transistor Q1. The capacitor C1 allows the AC component of the audio input to pass, while blocking the DC bias voltage established by R2 and R3 so that any preceding stage is not affected. The audio signal output from the collector of the transistor Q1 is provided to the emitter 104. The emitter 104 modulates light by the audio signal and emits the modulated light over a fiberless medium in the direction of the detector 106. The detector 106 replicates the audio signal from the modulated light. The replicated audio signal may then be output from the detector 106 to the next stage (not shown) through a DC-blocking capacitor C2.

A transistor Q2 may be used as a buffer to assist driving the next stage. The transistor Q2 may be configured as a common-emitter with the collector connected to the detector 104 and a resistor R4 connected between the collector and base.

The resistor values selected for biasing the components in the audio circuit 100 may very depending on the specific application and the overall design constraints imposed on the circuit. The resistor values may be selected by trial and error to optimize performance, which is well within the capabilities of one skilled in the art. An example of resistor values that may provide optimized performance for certain applications is 47 KΩ.

Similarly, the selection of capacitance values is well within the capabilities of one skilled in the art. Basically, any capacitance values may be selected that allow an AC signal to pass, while providing sufficient DC isolation between stages.

The audio circuit 100 may be implemented in a single package, multiple packages, discrete components, or any combination thereof. In a single package configuration, the audio circuit 100 may be implemented in a dual in line package for small signal applications and a single in line package for power applications.

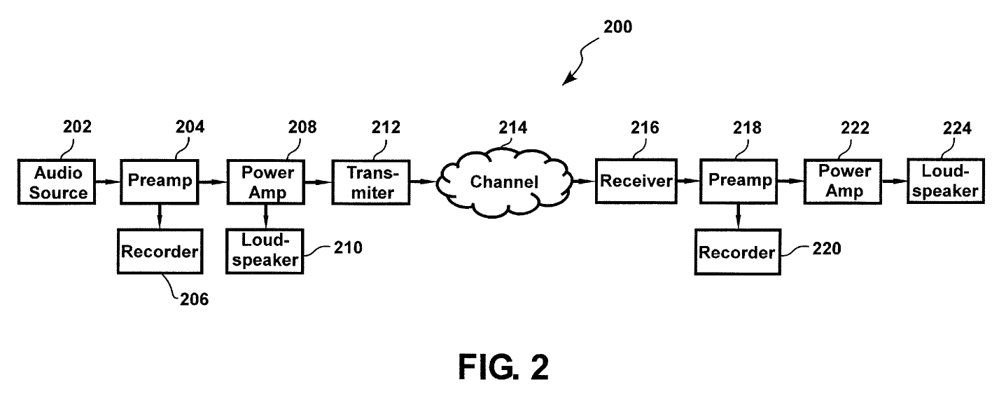

An application for optically coupled audio circuits will now be described with reference to FIG. 2. FIG. 2 is a functional block diagram illustrating an example of various permutations of an audio system. In this example, the audio system 200 comprises a number of audio stages. The audio circuit described in connection with FIG. 1 may be used in, or between, one of more of these stages. The implementation of these stages is well known in the art, and therefore, will only be described briefly for purposes of clarity and completeness. The integration of the audio circuit of FIG. 1 into, or between, one or more of these stages is well within the capabilities of one skilled in the art.

The audio system 200 is shown with an audio source 202. The audio source 202 may be a microphone, a radio tuner, a tape player, a CD-player, a DVD-player, or other similar audio source. Alternatively, the audio source 202 may be digital files (e.g., MP3 files), as might be the case when the audio system 200 is a digital audio player.

The audio signal from the audio source 202 may be provided to a preamplifier 204. The preamplifier 204 may be used to condition the audio signal by providing amplification, filtering, frequency correction, volume/tone control, and/or other signal conditioning functions. In at least one configuration of the audio system, the preamplifier 204 provides the audio signal to a recorder 206 for storage on any suitable storage medium.

The preamplifier 204 also provides the audio signal to a power amplifier 208. The purpose of the power amplifier 208 is to amplify the audio signal to a level suitable for the next stage. In at least one configuration of the audio system 200, the power amplifier 208 is used to drive a loudspeaker 210. Alternatively, or in addition to, the power amplifier 208 may be used to provide the audio signal to a transmitter 212 for transmission over a wired or wireless communication channel 214 to a receiver 216. The receiver 216 may be used to provide the audio signal to audio stages, similar to those in the transmitting end, including a preamplifier 218, a recorder 220, a power amplifier 222, a loudspeaker 224, and/or any combination of suitable audio stages.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. An audio circuit configured to receive an analog audio signal, comprising:
a LED configured to emit light modulated by the analog audio signal over a fiberless medium; and
a detector configured to replicate the analog audio signal received by the LED from the modulated light emitted from the LED.

2. The audio circuit of claim 1 wherein the LED and detector are configured to be coupled to a common voltage source.

3. The audio circuit of claim 1 wherein each of the LED and detector is configured to receive a continuous bias current.

4. The audio circuit of claim 1 wherein the LED is an infra-red LED and the detector is an infra-red detector.

5. The audio circuit of claim 1 further comprising a driver configured to provide the analog audio signal received by the audio circuit to the LED.

6. The audio circuit of claim 1 further comprising a buffer coupled to an output of the detector.

7. The audio circuit of claim 1 further comprising a single package containing the LED and detector.

8. An audio circuit, comprising:
an audio signal input;
a LED coupled to the audio signal input;
a detector optically coupled to the LED through a fiberless medium;
an audio signal output, the detector being coupled to the audio signal output; and
a voltage input, each of the LED and detector being coupled to the voltage input.

9. The audio circuit of claim 8 wherein the LED is an infra-red LED and the detector is an infra-red detector.

10. The audio circuit of claim 8 further comprising a driver, the LED being coupled to the signal input through the driver.

11. The audio circuit of claim 10 wherein the driver comprises a transistor.

12. The audio circuit of claim 10 wherein the LED comprises an anode and cathode, and wherein the driver comprises a bipolar transistor having a collector coupled to the anode of the LED and an emitter coupled to the cathode of the LED, the bipolar transistor further comprising a base coupled to the signal input.

13. The audio circuit of claim 12 further comprising a resistor, each of the cathode of the LED and the collector of the bipolar transistor being coupled to the voltage input through the resistor.

14. The audio circuit of claim 13 further comprising a voltage return input, each of the anode of the LED and the emitter of the transistor being coupled to the voltage return input.

15. The audio circuit of claim 12 further comprising a resistor coupled between the collector and the base of the transistor.

16. The audio circuit of claim 8 wherein the detector comprises a collector coupled to the voltage input and an emitter coupled to the signal output.

17. The audio circuit of claim 16 further comprising a resistor coupled between the voltage input and the collector of the detector.

18. The audio circuit of claim 16 further comprising a transistor coupled to the emitter of the detector.

19. The audio circuit of claim 18 further comprising a voltage return input, wherein the transistor comprises a bipolar transistor having a base and collector, wherein each of the base and collector is coupled to the signal output, the transistor further comprising an emitter coupled to the voltage return input.

20. The audio circuit of claim 19 further comprising a resistor coupled between the collector and base of the transistor.

21. The audio circuit of claim 8 further comprising a single package containing the LED and detector.

22. An audio circuit configured to receive an analog audio signal, comprising:
means for emitting light modulated by the analog audio signal over a fiberless medium; and
means for replicating the analog audio signal in response to the emitted modulated light.

23. The audio circuit of claim 22 wherein the means for emitting modulated light and the means for replicating the analog audio signal are configured to be coupled to a common voltage source.

24. The audio circuit of claim 22 wherein each of the means for emitting modulated light and the means for replicating the analog audio signal is configured to receive a continuous bias current.

25. The audio circuit of claim 22 further comprising means for providing the analog audio signal to the means for emitting modulated light.

26. The audio circuit of claim 22 further comprising means for buffering the replicated analog audio signal.

27. The audio circuit of claim 22 further comprising a single package containing the means for emitting light and the means for replicating the analog audio signal.

28. An audio circuit configured to receive an analog audio signal, comprising:
an optical coupler configured to amplify the analog audio signal.

29. The audio circuit of claim 28 wherein the optical coupler comprises an emitter configured to emit light modulated by the analog audio signal over a fiberless medium, and a detector configured to replicate the analog audio signal received by the LED from the modulated light emitted from the LED.

30. The audio circuit of claim 28 wherein the emitter and detector are configured to be coupled to a common voltage source.

31. The audio circuit of claim 28 further comprising a single package containing the emitter and detector.

32. The audio circuit of claim 28 wherein each of the LED and detector is configured to receive a continuous bias current.

33. The audio circuit of claim 28 further comprising a driver configured to provide the analog audio signal received by the audio circuit to the optical coupler.

34. The audio circuit of claim 28 further comprising a buffer coupled to an output of the optical coupler.

35. An audio system configured to receive an analog audio signal, comprising, comprising:
a plurality of audio stages, wherein at least one of the stages includes an audio circuit having a LED configured to emit light modulated by the analog audio signal over a fiberless medium, and a detector configured to replicate the analog audio signal received by the LED from the modulated light emitted from the LED.

36. The audio system of claim 35 wherein the LED and detector are configured to be coupled to a common voltage source.

37. The audio system of claim 35 wherein each of the LED and detector is configured to receive a continuous bias current.

38. The audio system of claim 35 wherein the LED is an infra-red LED and the detector is an infra-red detector.

39. The audio system of claim 35 further comprising a driver configured to provide the analog audio signal received by the audio circuit to the LED.

40. The audio system of claim 35 further comprising a buffer coupled to an output of the detector.

41. The audio system of claim 35 further comprising a single package containing the LED and detector.
